(19) United States
(12) Patent Application Publication
(10) Pub. No.: US 2026/0183788 A1
(43) Pub. Date: Jul. 2, 2026

(54) AN ARRANGEMENT AND A METHOD FOR APPLYING PAINT ON AN ARTICLE

(71) Applicant: Inter IKEA Systems B.V., Delft (NL)

(72) Inventors: Peter JONSSON, Diö (SE); Martin STRAND, Växjö (SE)

(73) Assignee: Inter IKEA Systems B.V., Delft (NL)

(21) Appl. No.: 19/125,058

(22) PCT Filed: Oct. 27, 2023
(86) PCT No.: PCT/SE2023/051063

§ 371 Date: Apr. 28, 2025

(30) Foreign Application Priority Data
Oct. 28, 2022 (SE) 2251257-8

(51) Int. Cl. B05C 1/02; B05D 1/28

(52) U.S. Cl. CPC B05C 1/02; B05D 1/28

(57) ABSTRACT

An arrangement may be provided for applying paint on an article provided with a three-dimensional external shape. The arrangement may include at least one conveyor for forwarding the article, a first paint application roller, and a second paint application roller arranged downstream of the first paint application roller. The peripheral surface of the first paint application roller may be relatively soft so that it may be flattened out by the article and thereby reach a lowermost surface of the three-dimensional external shape. A peripheral surface of the second paint application roller may be relatively hard and the second paint application roller is arranged so that the peripheral surface may engage with the article in a way distributing the paint applied by the first paint application roller.

### TECHNICAL FIELD

The invention relates to an arrangement for applying paint on an article provided with a three-dimensional external shape defining a main surface and at least one sub-surface that is depressed or elevated with regard to the main surface. The invention further relates to a method for applying paint on such an article.

The article's main surface may be flat and provided with depressions, such as straight notches. Such an article may be adapted for forming a panel for a piece of furniture, such as cabinet doors. The article may be in a wood material, such as chipboard, wherein the depressions may be formed by milled straight notches.

Roller coating is a flexible and stable surface treatment method, that is ideal for flat surfaces. However, it has not been used for three-dimensional surfaces due to the limitation of the rollers. Instead, three-dimensional surfaces have traditionally been coated by other techniques, like spraying. These alternative techniques mostly have downsides compared to roller coating; like higher paint application needed, higher waste and lower line speeds.

### SUMMARY

One object of the invention is to achieve an arrangement for applying paint on an article provided with a three-dimensional external shape, that is adapted for achieving a substantially even layer of paint on depressed or elevated sub-surfaces and on the edges between the main surface and the sub-surface and that is efficient with regard to speed and/or material consumption.

The object is achieved by an arrangement according to claim 1. Thus, it is achieved by an arrangement that comprises at least one conveyor for forwarding the article in a way that the three-dimensional external shape is exposed upwards, a first paint application roller, a paint delivery means associated to the first paint application roller and a second paint application roller, wherein the second paint application roller is arranged at a distance from the first paint application roller downstream of the first paint application roller in a forwarding direction of the at least one conveyor without any means for curing or drying of the paint applied on the article between the first paint application roller and the second paint application roller, wherein the first paint application roller is arranged above the at least one conveyor with its axis of rotation transversally relative to the forwarding direction of the at least one conveyor so that a peripheral surface of the first paint application roller may engage with the article, wherein the peripheral surface of the first paint application roller has such a hardness that it may be flattened out by the article and thereby reach a lowermost surface of the main surface and the sub-surface when the article is forwarded past the first paint application roller, wherein the second paint application roller is arranged above the at least one conveyor with its axis of rotation transversally relative to the forwarding direction of the at least one conveyor so that a peripheral surface of the second paint application roller may engage with the article in a way distributing the paint applied by the first paint application roller.

According to one example, one single conveyor is arranged for forwarding the article past both the first paint application roller and the second paint application roller. According to an alternative, the arrangement comprises a plurality of conveyors arranged downstream of each other in a forwarding direction for forwarding the article, wherein each one of the first paint application roller and the second paint application roller is associated to a separate conveyor.

According to one example, the paint is of a radiation curing type. According to an alternative, the paint may be a drying paint. Accordingly, the expression “without any means for curing or drying of the paint applied on the article between the first paint application roller and the second paint application roller” defines that there is no radiation means or other equipment for curing or drying of the paint applied on the article between the first paint application roller and the second paint application roller. Accordingly, the second paint application roller should distribute the paint applied by the first paint application roller while the paint is still wet. This process may be called “wet on wet” (without intermediate curing or drying). Accordingly, a distance between the first paint application roller and the second paint application roller may not be critical with regard to the functioning of the second paint application roller for the paint application.

According to one example, the arrangement regards application of a layer of paint via two paint application rollers, wherein the second paint application roller is arranged directly downstream the first paint application roller for distributing the paint applied by the first paint application roller while the paint is still wet. By arranging the first paint application roller and the second paint application roller close to each other, there is a reduced risk for dirt and/or dust from the environment to end up in the paint between the rollers.

According to one example, the expression “main surface” regards an outermost surface of the article. Further, the expression “sub-surface that is depressed with regard to the main surface” regards a lower surface spaced from the outermost surface of the article perpendicularly to an extension plane of the outermost surface. A main portion of the outer surface of the article may be formed by the main surface, wherein the sub-surface may form a pattern that has an aesthetic appearance. The sub-surface may be formed by linear depressions or notches. The sub-surface may be connected to the main surface via one or several straight and/or rounded edge surfaces adding to the aesthetic appearance.

According to an alternative example, the expression “main surface” regards a lowermost surface of the article. Further, the expression “sub-surface that is elevated with regard to the main surface” regards an upper surface spaced from the lowermost surface of the article perpendicularly to an extension plane of the outermost surface. A main portion of the outer surface of the article may be formed by the main surface, wherein the sub-surface may form a pattern that has an aesthetic appearance. The sub-surface may be formed by linear elongated elements/segments. The sub-surface may be connected to the main surface via one or several straight and/or rounded edge surfaces adding to the aesthetic appearance.

The term “peripheral surface” of a roller refers to the radially outer cylindrical surface of the roller.

The expression “the peripheral surface of the first paint application roller has such a hardness that it may be flattened out by the article” indicates that a nominal cylindrical outer surface of the first paint application roller is adapted for being reversibly deformed by the article when the article reaches the first paint application roller. Accordingly, an outermost layer of the first paint application roller that defines the peripheral surface has a relatively soft structure.

According to a first example, each one of the first paint application roller and the second paint application roller is arranged above the conveyor with its axis of rotation perpendicularly relative to the forwarding direction of the conveyor.

According to a further example, the conveyor comprises an endless belt extending around two spaced rollers, wherein one of the rollers may be a drive roller and the other one of the rollers may be a tension roller.

According to a further example, the arrangement comprises at least one support roller arranged in parallel with the first paint application roller and/or the second paint application roller and on an opposite side of the conveyor belt relative to the associated paint application roller. The support roller is arranged at a small distance from the associated paint application roller, wherein the conveyor runs between the rollers in a way that the support roller supports the conveyor belt from below during paint application.

Such an arrangement creates conditions for achieving a substantially even layer of paint across the edge between the main surface and the depressed or elevated sub-surface. Especially, the arrangement creates conditions for the paint to reach into deep milled notches and/or on a sharp edge between the main surface and the depressed sub-surface. In many rectangular flat shaped articles, such as cabinet doors, the edges between the main surface and the depressed sub-surface are sharp or even stepwise. Further, the notches and thereby the edges normally extend in parallel with a long side and/or a short side of such an article. Further, the article is normally forwarded on the conveyor with one of its sides in parallel with the forwarding direction. Accordingly, a first one of the notches/edges will extend in parallel to an axis of the paint application roller and a second one of the notches/edges will extend perpendicular to the axis of the paint application roller. The first one of the edges may present a transition from a higher surface (the main surface) to a lower surface (the sub-surface) when passing the paint application roller, wherein there is a challenge to reach all the way down to the subsurface directly adjacent the edge. On the other hand, the first one of the edges may present a transition from a lower surface (the sub-surface) to a higher surface (the main surface) when passing the paint application roller, wherein there is a challenge to apply paint on the main surface directly adjacent the edge. The second one of the edges extending perpendicular to the axis of the paint application roller presents a challenge for even paint application in that the peripheral surface of the first paint application roller must be adapted for a continuous contact of the upper surface of the article across the edge. The arrangement as defined by claim 1 is adapted for achieving sufficient paint application on the depressed sub-surface and each one of the first and second edges between the depressed sub-surface and the main surface.

According to one embodiment example, the peripheral surface of the second paint application roller has such a hardness that it may substantially not be flattened out by the article or may be flattened out to a significantly less extent than the peripheral surface of first paint application roller. Accordingly, an outermost layer of the second paint application roller that defines the peripheral surface has a relatively hard structure.

According to a further embodiment example, the first paint application roller is arranged so that its axis of rotation is at a first distance from the upper surface of the at least one conveyor in an operational state, wherein the second paint application roller is arranged so that its axis of rotation is at a second distance from the upper surface of the at least one conveyor in an operational state, wherein the first paint application roller and the second paint application roller are arranged so that a difference between the first distance and a nominal radius of the first paint application roller is smaller than a difference between the second distance and a nominal radius of the second paint application roller.

The term “nominal radius” refers to a distance between an axis of rotation and a circular-cylindrical outer surface of the roller.

The term “operational state” refers to a state, in which the respective roller is in operation for paint application on articles.

According to one example, the first paint application roller is arranged so that a peripheral surface of the first paint application roller is at a first distance from an upper surface of the at least one conveyor forming a first gap and the second paint application roller is arranged so that a peripheral surface of the second paint application roller is at a second distance from the upper surface of the at least one conveyor forming a second gap, wherein the second distance is longer than the first distance.

Such a relative positioning in height of the first paint application roller and the second paint application roller creates conditions for the first paint application roller to reach longer into the depressions than the second paint application roller, wherein the second paint application roller has the purpose to distribute or even out the paint applied by the first paint application roller. It has turned out that such a relative height positioning of the first paint application roller and the second paint application roller creates conditions for a generally even applied paint layer on articles like cabinet doors with milled notches.

According to a further embodiment example, the difference between the first distance and the nominal radius of the first paint application roller is in an interval of 1-5 mm smaller than the difference between the second distance and the nominal radius of the second paint application roller.

According to a further embodiment example, the peripheral surface of the first paint application roller 34 has a Shore A value in an interval of 5-25, preferably 7-20, and most preferably 8-15.

According to a further embodiment example, an outer surface of the first paint application roller has a Shore A value in an interval of 10-25. In other words, the first paint application roller may be considered as a “soft roller”. The first paint application roller having such a low hardness on its outer surface creates further conditions for the first paint application roller to be arranged relatively close to the conveyor and reach relatively deep into the depressions. According to one example, the Shore A value is below 20 and especially in an interval of 10-15.

According to one example, the first paint application roller comprises a cylindrical core, which may be in an interval of 180-200 mm in diameter and according to a preferred example about 190 mm in diameter. The cylindrical core may be provided with a soft outer layer with a depth in an interval of 20-30 mm and according to a preferred example about 25 mm. The cylindrical core may be of a metallic material, such as steel. The soft layer may be in a material of PolyUrethane (PU), Ethylene Propylene Diene Monomer (EPDM) rubber or silicone.

According to a further embodiment example, the first paint application roller is arranged in a way that its axis of rotation is at a first fixed distance from the upper surface of the conveyor in an operational state. In other words, the first paint application roller is arranged so that its axis of rotation is fixed during operation. Thus, the axis of rotation of the first paint application roller will not flex upwards when the forwarded article penetrates the peripheral surface of the first paint application roller.

According to a further embodiment example, an outer surface of the second paint application roller has a Shore A value in an interval of 26-60, preferably 30-50. In other words, the second paint application roller may be considered as a “hard roller”. The second paint application roller having such high hardness on its outer surface creates further conditions for the second paint application roller to distribute/level out the paint applied in a proper way.

According to a further embodiment example, the second paint application roller is arranged in a way that its axis of rotation is at a second fixed distance from the upper surface of the conveyor in an operational state. In other words, the second paint application roller is arranged so that its axis of rotation is fixed during operation. Thus, the axis of rotation of the first paint application roller will not flex upwards when the forwarded article contacts the peripheral surface of the second paint application roller.

According to a further example, the conveyor is adapted to forward the article with a speed in an interval of 5-50 meter per minute. It has turned out that a conveyor speed in the interval of 5-50 meter per minute is suitable for achieving an even paint layer, especially across transitions to depressed areas, by means of the arrangement as defined above.

According to a further embodiment example, the arrangement comprises a paint delivery means associated to the second paint application roller. Thus, in addition to paint delivery to the first paint application roller, the arrangement provides for paint delivery also to the second paint application roller. According to one example, the amount of paint delivered to the first paint application roller is substantially higher than the amount of paint delivered to the second paint application roller per unit time. It has turned out that adding a smaller amount of paint to the second roller may contribute to achieving an even paint layer.

A further object of the invention is to achieve a machine for applying multiple layers of paint on an article provided with a three-dimensional external shape, that is adapted for achieving a substantially even layer of paint on depressed or elevated sub-surfaces and on the edges between the main surface and the sub-surface and that is efficient with regard to speed and/or material consumption.

The object is achieved by a machine according to claim 10. Thus, it is achieved by a machine that comprises at least one conveyor for forwarding the article and a plurality of paint application stations arranged downstream of each other in a forwarding direction of the conveyor, wherein each one of the paint application stations is adapted to apply one layer of paint on the article, wherein at least one of the paint application stations comprises an arrangement according to any one of the above examples.

According to one embodiment example, the machine comprises a means for curing or drying of the paint applied on the article between two adjacent paint application stations. According to one example, the means for curing or drying comprises a radiation source, such as a UV/ARC lamp or UV/LED.

A further object of the invention is to achieve a method for applying paint on an article provided with a three-dimensional external shape, that is adapted for achieving a substantially even sufficient layer of paint on depressed or elevated sub-surfaces and on the edges between the main surface and the sub-surface and that is efficient with regard to speed and/or material consumption.

The object is achieved by a method according to claim 12. Thus, it is achieved by a method comprising the steps of
providing the article that has a three-dimensional external shape defining a main surface and at least one sub-surface that is depressed or elevated with regard to the main surface,
forwarding the article past a first paint application roller and a second paint application roller,
applying paint by means of the first paint application roller in a way that a peripheral surface of the first paint application roller is flattened out by the article and reach a lowermost surface of the main surface and the sub-surface when the article is forwarded past the first paint application roller,
distributing the paint applied by the first paint application roller by a second paint application roller by allowing a peripheral surface of the second paint application roller to engage with the article,
without performing any active drying of the paint applied on the article between the first paint application roller and the second paint application roller.

According to one embodiment example, the method comprises the step of applying a pressure of a first magnitude to the article by the first paint application roller and applying a pressure of a second magnitude to the article by the second paint application roller, wherein the pressure applied by the first paint application roller is substantially higher than the pressure applied by the second paint application roller.

According to a further embodiment example, the method comprises the step of applying a pressure by the first paint application roller in a range of 15-20 g/m².

According to a further embodiment example, the method comprises the step of applying a pressure by the second paint application roller in a range of −5-10 g/m².

According to a further embodiment example, the method comprises the steps of applying a first layer of paint on the article by means of the first paint application roller and the second paint application roller, curing or drying of the first layer of paint applied on the article, and applying a second layer of paint on the article in a similar way as the first layer of paint in a consecutive step after the curing or drying step.

According to a further embodiment example, the method comprises the step of forwarding the article past the first paint application roller and the second paint application roller with a speed in an interval of 5-50 meter per minute.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a perspective view from above of an article in the form of a cabinet door, that should be painted,

FIG. 2 is a schematic side view of a paint application arrangement according to a first embodiment for applying paint on the cabinet door in FIG. 1,

FIG. 3 is a close-up view of the article and a paint application roller in cross section during paint application,

FIG. 4 is a schematic side view of machine for applying multiple layers of paint on the cabinet door in FIG. 1, wherein the machine comprises the paint application arrangement in FIG. 2,

FIG. 5 is a schematic cross section view of the cabinet door after paint application by means of the machine in FIG. 4, and

FIG. 6 is a perspective view of a machine comprising the paint application arrangement in FIG. 1.

### DETAILED DESCRIPTION OF EXAMPLE EMBODIMENTS

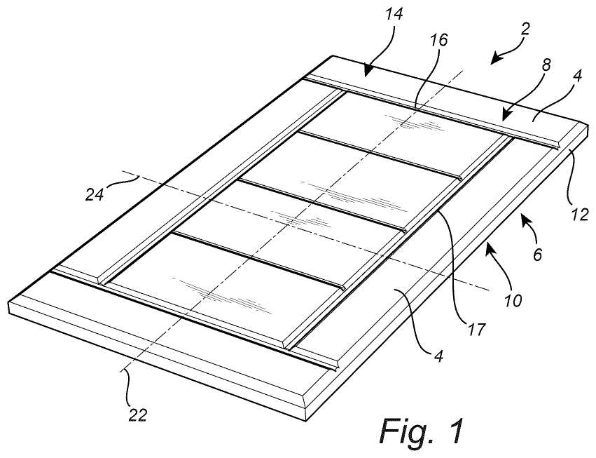

FIG. 1 is a perspective view from above of an article 2 in the form of a cabinet door, that is prepared for being painted. The article may alternatively be termed substrate. The article 2 has a generally rectangular shape. The article 2 has two opposite main surfaces 4, 6, ie outermost surfaces, that face in opposite directions and define opposite sides 8, 10 of the article. The two opposite main surfaces 4, 6 are in parallel with each other. Further, a peripheral edge surface 12 connects the two opposite main surfaces 4, 6. More specifically, the peripheral edge surface 12 defines a thickness of the article 2. The peripheral edge surface 12 extends in a plane generally perpendicular to an extension plane in parallel with the main surfaces 4, 6.

The article 2 is provided with a three-dimensional external shape 14 on at least one 8 of the sides the article 2. The three-dimensional external shape 14 defines the main surface 4 and at least one sub-surface 16, 17 that is depressed with regard to the main surface. Thus, the sub-surface 16, 17 regards a lower surface spaced from the outermost surface 4 of the article 2 perpendicularly to an extension plane of the outermost surface 4. Each one of the sub-surfaces 16, 17 extends along a straight line and is formed by a milled notch.

The article 2 has a longitudinal extension 22 and a transverse extension 24 perpendicularly to the longitudinal extension 22. A first sub-surface 16 extends in parallel with the transverse extension 24. A second sub-surface 17 extends in parallel with the longitudinal extension 22.

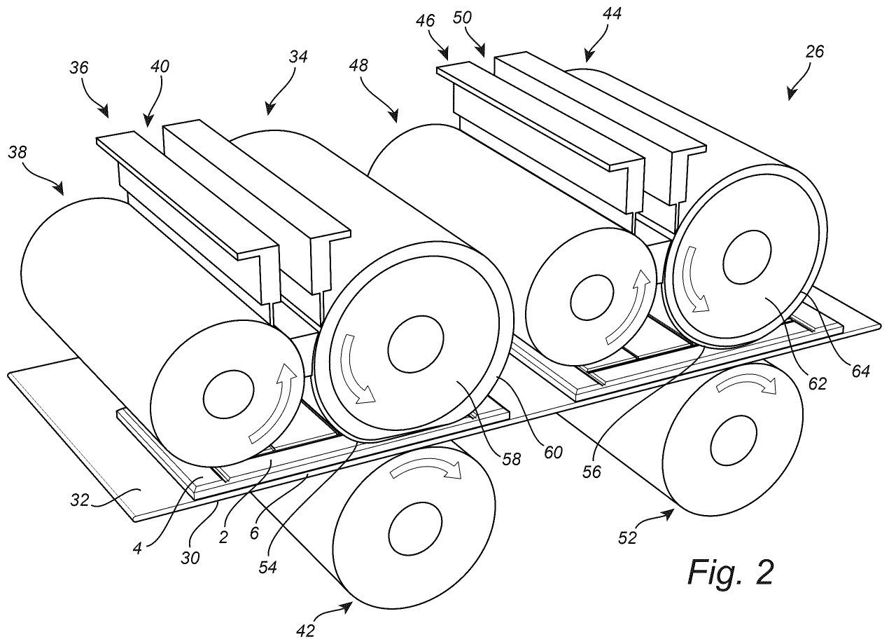

FIG. 2 is a schematic side view of a paint application arrangement 26 according to a first embodiment for applying paint on the article 2 in FIG. 1.

The arrangement 26 comprises a conveyor 28 for forwarding the article 2. The conveyor 28 comprises an endless belt 30 extending around two spaced rollers (not shown), wherein one of the rollers may be a drive roller and the other one of the rollers may be a tension roller. The endless belt 30 comprises an upper surface 32 adapted to carry the article 2. More specifically, the article 2 is positioned on the belt 30 so that a second main surface 6 of the article is in contact with the upper surface 32 of the belt 30, wherein the first main surface 4 of the article faces upwards and is exposed for being painted.

The arrangement 26 further comprises a first paint application roller 34 and a paint delivery means 36 associated to the first paint application roller 34. The first paint application roller 34 is arranged above the conveyor 28 with its axis of rotation perpendicularly relative to the forwarding direction of the conveyor 28. The paint delivery means 36 comprises a first doctor roller 38 arranged with its axis of rotation in parallel with the axis of rotation of the first paint application roller 34. Further, the first doctor roller 38 is arranged in the vicinity of the first paint application roller 34 in a way forming a gap between the rollers 34, 38. Further, the paint delivery means 36 comprises a paint container 40 with an outlet directed for providing paint to the rollers 34, 38.

The arrangement 26 further comprises a first support roller 42 arranged in parallel with the first paint application roller 34 and on an opposite side of the conveyor belt 30 relative to the first paint application roller 34. The first support roller 42 is arranged at a small distance from the first paint application roller 34, wherein the conveyor belt 30 runs between the rollers 34, 42 in a way that the first support roller 42 supports the conveyor belt from below during paint application.

The arrangement 26 further comprises a second paint application roller 44 and a paint delivery means 46 associated to the first paint application roller 34. The second paint application roller 44 is arranged at a distance from the first paint application roller 34 downstream of the first paint application roller 34 in a forwarding direction of the conveyor 28 without any means for curing or drying of the paint applied on the article between the first paint application roller 34 and the second paint application roller 44. Further, the second paint application roller 44 is arranged above the conveyor 28 with its axis of rotation perpendicularly relative to the forwarding direction of the conveyor 28.

The paint delivery means 46 comprises a second doctor roller 48 arranged with its axis of rotation in parallel with the axis of rotation of the second paint application roller 44. Further, the second doctor roller 48 is arranged in the vicinity of the second paint application roller 44 in a way forming a gap between the rollers 44, 48. Further, the paint delivery means 46 comprises a paint container 50 with an outlet directed for providing paint to the rollers 44, 48.

The arrangement 26 further comprises a second support roller 52 arranged in parallel with the second paint application roller 44 and on an opposite side of the conveyor belt 30 relative to the second paint application roller 44. The second support roller 52 is arranged at a small distance from the second paint application roller 44, wherein the conveyor belt 30 runs between the rollers 44, 52 in a way that the second support roller 52 supports the conveyor belt from below during paint application.

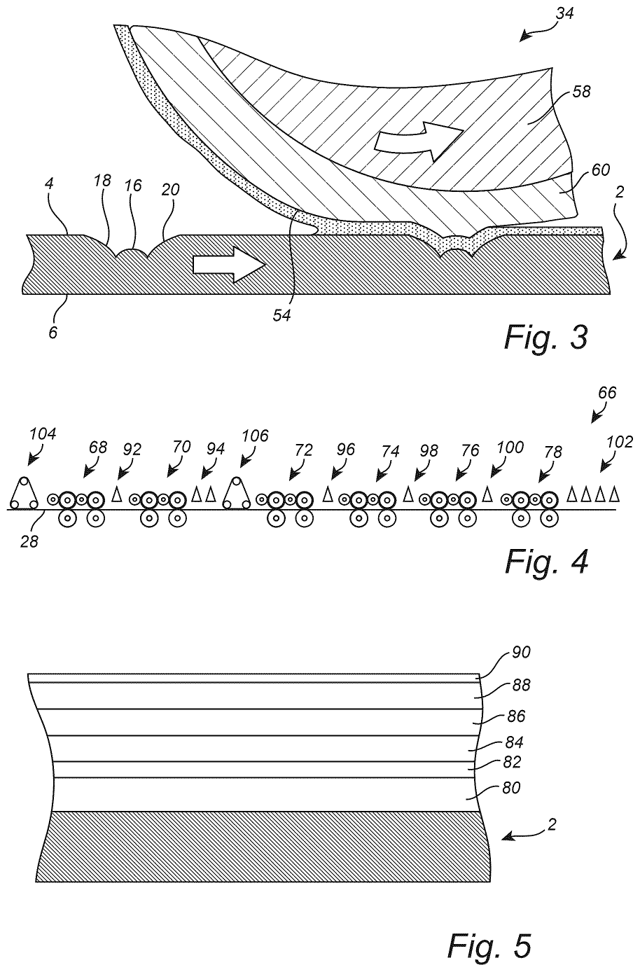

The first paint application roller 34 is arranged above the conveyor 28 so that a peripheral surface 54 of the first paint application roller 34 is at a first distance from the upper surface 32 of the conveyor forming a first gap allowing the peripheral surface 54 to engage with the first main surface 4 of the article 2 in a way that the peripheral surface 54 is flattened out by the article 2 and reach the sub-surface 16 when the article is forwarded past the first paint application roller 34, see also FIG. 3. Accordingly, the first distance is smaller than a distance between the sub-surface 16 and a lowermost surface of the article 2 resting on the conveyor 28.

The peripheral surface 54 of the first paint application roller 34 has a Shore A value in an interval of 5-25, preferably 7-20, and most preferably 8-15. Thus, the first paint application roller 34 may be considered to be relatively soft. The first paint application roller 34 comprises a cylindrical core 58 of a metallic material and a layer 60 of a relatively soft material around the cylindrical core 58. The cylindrical core 58 has a diameter around 200 mm and the layer 60 has a thickness of at least 25 mm. The soft layer 60 is formed in rubber and more particularly of one of EPDM, PU, Silicol or Butyl.

The second paint application roller 44 is arranged above the conveyor 28 so that a peripheral surface 56 of the second paint application roller is at a second distance from the upper surface 32 of the conveyor forming a second gap. The second distance is longer than the first distance, allowing the peripheral surface 56 of the second paint application roller 44 to engage with the main surface 4 of the article in a way distributing the paint applied by the first paint application roller. More specifically, the second paint application roller 44 is arranged above the conveyor 28 so that its peripheral surface 56 does not reach to the sub-surface 16.

The peripheral surface 56 of the second paint application roller 44 has a Shore A value in an interval of 26-60, preferably 30-50. Thus, the second paint application roller 44 may be considered to be relatively hard. The second paint application roller 34 comprises a cylindrical core 62 of a metallic material and a layer 64 of a relatively soft material around the cylindrical core 62. The cylindrical core 62 has a diameter around 200 mm and the layer 64 has a thickness of at least 5 mm. The soft layer 64 is formed in rubber and more particularly of one of EPDM and PU.

The first paint application roller 34 and the second paint application roller 44 are arranged relative to the conveyor 28 so that the second distance between the peripheral surface 56 of the second paint application roller 44 and the upper surface 32 of the conveyor is in an interval of 1-5 mm longer than the first distance between the peripheral surface 56 of the first paint application roller 34 and the upper surface 32 of the conveyor.

FIG. 3 is a close-up view of the article 2 and the first paint application roller 34 in cross section during paint application. A specific profile of the milled notch is shown, wherein the sub-surface 16 is connected to the main surface 4 via one or several straight and/or rounded surfaces 18, 20 bridging the distance between the sub-surface 16 and the main surface 4. Further, it is shown that the peripheral surface 54 of the first paint application roller 34 is flattened out by the article 2 and reach the sub-surface 16 when the article is forwarded past the first paint application roller 34

FIG. 4 is a schematic side view of a paint application line 66 for applying multiple layers of paint on the article in FIG. 1, wherein the paint application line 66 comprises the paint application arrangement 26 in FIG. 2. FIG. 5 is a schematic cross section view of the article after paint application by means of the paint application line 66 in FIG. 4.

The paint application line 66 comprises the conveyor 28 for forwarding the article 2 and a plurality of paint application stations 68, 70, 72, 74, 76, 78 arranged downstream of each other in a forwarding direction of the conveyor 28.

The article 2 is made of wood or a wood-based material having open pores. The pores may be sealed with a closed sealing layer. Each one of the first two paint application stations 68, 70 is therefore adapted to apply a filler/sealer, see layers 80, 82 in FIG. 4 to close the wood based article.

Each one of the three following paint application stations 72, 74, 76 is adapted to apply a base coat defining a colour, see layers 84, 86, 88 in FIG. 4. The last paint application station 78 is adapted to apply a top coat, see layer 90 in FIG. 4. Each one of the paint application stations 72, 74, 76 that is adapted to apply a base coat comprises an arrangement 26 according to FIG. 2.

Further, the paint application line 66 comprises a means 92, 94, 96, 98, 100, 102 for curing or drying of the paint applied on the article 2 downstream of each one of the paint application stations 68, 70, 72, 74, 76, 78. The means 92, 94, 96, 98, 100, 102 for curing or drying of the paint is formed by a UV radiating light source, such as a UV/ARC lamp or UV/LED. Accordingly, the coating layer is cured or dried after each paint application step.

Further, the paint application line 66 comprises means 104, 106 for sanding the article. A first sanding means 104 is arranged upstream of the first paint application station 68. A second sanding means 106 is arranged downstream of the second paint application station 70 that applies the second filler/sealer and upstream of the first paint application station 72 that is adapted to apply the first base coat. The sanding may be performed with sanding paper and/or brush sanding. Sanding may not be needed for each paint application step.

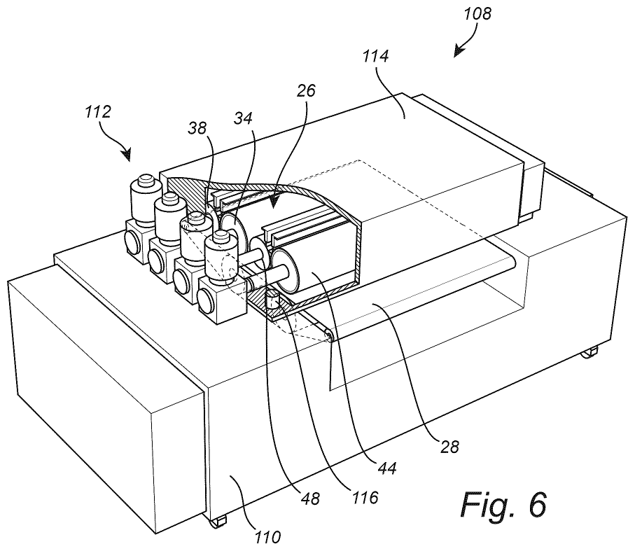

FIG. 6 is a perspective view of a machine 108 comprising the paint application arrangement 26 in FIG. 1. The machine 108 comprises a stand 110 that is adapted to support the conveyor 28. Further, the machine 108 comprises motors 112 for driving the rollers 34, 38, 44, 48. Further, the machine 108 comprises means 116 for raising/lowering the upper rollers 34, 38, 44, 48 in relation to the upper surface 32 of the conveyor 28. The upper rollers 34, 38, 44, 48 are arranged in an upper portion 114 of the machine. The means 116 for raising/lowering the upper rollers 34, 38, 44, 48 comprises a set of cylinders acting on each one of the rollers 34, 38, 44, 48 for individually setting a desired vertical position of the roller. Accordingly, a desired pressure between the respective paint application roller 34, 44 and the article 2 that is forwarded on the conveyor 28 for being painted may be set.

### Production Example

| | | 1st Roller | | 2nd Roller | | | |
|---|---|---|---|---|---|---|---|
| | | (soft roller) | | (harder roller) | | Total | |
| | | Pressure* | | Pressure* | | average | |
| Layer | Paint application layers | 3-5 mm | | 0.5-1 mm | | application | |
| 1 | White sealer (High viscosity low pigment) | 25-30 | g/m² | −10-15 | g/m² | 10-20 | g/m² |
| 2 | White sealer (High viscosity low pigment) | 25-30 | g/m² | −10-15 | g/m² | 10-20 | g/m² |
| 3 | White base coat (Low viscosity high | 15-20 | g/m² | −5-10 | g/m² | 5-15 | g/m² |
| | pigment) | | | | | | |
| 4 | White base coat (Low viscosity high | 15-20 | g/m² | −5-10 | g/m² | 5-15 | g/m² |
| | pigment) | | | | | | |
| 5 | White base coat (Low viscosity high | 15-20 | g/m² | −5-10 | g/m² | 5-15 | g/m² |
| | pigment) | | | | | | |
| 6 | Top coat | 5-6 | g/m² | ±0 | g/m² | 5-6 | g/m² |
| 7 | Top coat | 5-6 | g/m² | ±0 | g/m² | 5-6 | g/m² |
| | Total | | | | | 40-97 | g/m² |

*The pressure describes the height of the application roller. For example, if the substrate is 20 mm thick, and the application roller is set to 15 mm, the pressure is 5 mm.

The 1st Roller is a soft roller. The 2nd roller is a hard roller and the coating is applied wet on wet (without intermediate curing or drying). The 2nd roller is smoothing the coating and either remove and redistribute some coating or just redistribute.

This example shows a 7-layer application, all applications wet on wet. This would result in a ready surface. For combination systems, for example finalizing the surface with spraying, less layers above, would be needed.

According to the embodiment described above, the first two layers used on wood based boards are clear fillers/sealers. Pigmented products have a higher cost, compared to the clear sealers, therefor this is the most cost-efficient way to paint. The function for the sealer is to close the board and it should be sanded to get a smooth surface by sanding, before the colored base coat is used.

According to an alternative, a sealer is used containing pigments. It may be beneficial in some applications using soft rollers to create an even layer of paint, especially across sharp edges between the main surface and the sub-surface.

According to a complement or alternative to the abovementioned embodiment, the article may be positioned on the conveyor in an angled orientation so that sharp/steep linear transitions, such as formed by milled notches, between the main surface and the sub-surface may enter the paint application rollers with an angle that is substantially different from 90° and different from 180°. According to one example, the article may be oriented on the conveyor in a way that its longitudinal direction has an angle of 45° in relation to a forwarding direction of the conveyor. Accordingly, the peripheral surface of the roller will gradually engage the transition during forwarding of the article past the roller. It has been showed to have a positive effect to get the coating in an even layer across the transition.

According to a further complement or alternative to the abovementioned embodiment, the layout of the machine is designed so that the article will be painted by the paint application roller from two opposite directions. In this way, any uneven layer of paint applied at transitions, such as milled notches, between the main surface and the sub-surface that approach the paint application roller in parallel with the paint application roller in a first paint application step may be evened out in a downstream paint application step if the article approaches the paint application roller in the downstream step in an angled orientation (turned 180°). This can be done in two ways; a turner is arranged between the two paint application steps, that is adapted to turn the article 180°. It may be achieved via a line of three consecutive linear conveyors, wherein the first conveyor and the third conveyor are arranged in parallel with each other, spaced from each other and running in opposite feeding directions. The second conveyor is arranged perpendicularly to the first and third conveyors and is adapted to join a downstream end of the first conveyor with an upstream end of the third conveyor so that an article may travel from the first conveyor to the second conveyor and further to the third conveyor. An article forwarded on the conveyors will then travel with a first end first on the first conveyor and with a second end, opposite the first end first on the third conveyor. According to an alternative, the article is removed from the conveyor downstream of a paint application step and reintroduced upstream of the same paint application step with an orientation that is turned around 180°.

It is to be understood that the present invention is not limited to the embodiments described above and illustrated in the drawings; rather, the skilled person will recognize that many changes and modifications may be made within the scope of the appended claims.

The direction of rotation of the rollers are indicated in FIG. 2 with arrows according to the first embodiment. It may be noted that the direction of rotation of one or several of the rollers may differ from the ones indicated in FIG. 2. For example, the first doctor roller 38 is in FIG. 2 indicated for being rotated in a counterclockwise direction. The first doctor roller 38 in FIG. 2 may alternatively be arranged for rotation in a clockwise direction, ie in a direction opposite to the rotational direction of its associated first paint application roller 34. In other words, the first doctor roller 38 in FIG. 2 may alternatively go reverse.

1. An arrangement for applying paint on an article provided with a three-dimensional external shape defining a main surface and at least one sub-surface that is depressed or elevated with respect to the main surface, the arrangement comprising:
at least one conveyor for forwarding the article in a way that the three-dimensional external shape is exposed upwards, a first paint application roller, a paint delivery means associated with the first paint application roller, and a second paint application roller;
wherein the second paint application roller is arranged at a distance from the first paint application roller downstream of the first paint application roller in a forwarding direction of the at least one conveyor without any device for curing or drying of the paint applied on the article between the first paint application roller and the second paint application roller;
wherein the first paint application roller is arranged above the at least one conveyor with its axis of rotation being transverse to the forwarding direction of the at least one conveyor so that a peripheral surface of the first paint application roller is engageable with the article;
wherein the peripheral surface of the first paint application roller has such a hardness that it may be flattened out by the article and thereby reach a lowermost surface of the main surface and the sub-surface when the article is forwarded past the first paint application roller;
wherein the second paint application roller is arranged above the at least one conveyor with its axis of rotation being transverse to the forwarding direction of the at least one conveyor so that a peripheral surface of the second paint application roller is engageable with the article in a way distributing the paint applied by the first paint application roller.

2. The arrangement according to claim 1, wherein the peripheral surface of the second paint application roller has such a hardness that it may substantially not be flattened out by the article or may be flattened out to a significantly less extent than the peripheral surface of the first paint application roller.

3. The arrangement according to claim 1, wherein the first paint application roller is arranged so that its axis of rotation is at a first distance from an upper surface of the at least one conveyor in an operational state;
wherein the second paint application roller is arranged so that its axis of rotation is at a second distance from the upper surface of the at least one conveyor in an operational state;
wherein the first paint application roller and the second paint application roller are arranged so that a difference between the first distance and a nominal radius of the first paint application roller is smaller than a difference between the second distance and a nominal radius of the second paint application roller.

4. The arrangement according to claim 3, wherein the difference between the first distance and the nominal radius of the first paint application roller is in an interval of 1-5 mm smaller than the difference between the second distance and the nominal radius of the second paint application roller.

5. The arrangement according to any preceding-claim 1, wherein the peripheral surface of the first paint application roller has a Shore A value in an interval of 5-25.

6. The arrangement according to claim 1, wherein the first paint application roller is arranged in a way that its axis of rotation is at a first fixed distance from an upper surface of the conveyor in an operational state.

7. The arrangement according to claim 1, wherein the peripheral surface of the second paint application roller has a Shore A value in an interval of 26-60.

8. The arrangement according to any-preceding-claim 1, wherein the second paint application roller is arranged in a way that its axis of rotation is at a second fixed distance from an upper surface of the conveyor in an operational state.

9. The arrangement according to claim 1, comprising a paint delivery means associated with the second paint application roller.

10. A machine for applying multiple layers of paint on an article provided with a three-dimensional external shape defining a main surface and at least one sub-surface that is depressed or elevated with respect to the main surface, the machine comprising:
at least one conveyor for forwarding the article in a way that the three-dimensional external shape is exposed upwards and a plurality of paint application stations arranged downstream of each other in a forwarding direction of the conveyor;
wherein each one of the paint application stations is adapted to apply one layer of paint on the article;
wherein at least one of the paint application stations is an arrangement according to claim 1.

11. The machine according to claim 10, comprising means for curing or drying of the paint applied on the article between two adjacent paint application stations.

12. A method for applying paint on an article, the method comprising:
providing the article that has a three-dimensional external shape defining a main surface and at least one sub-surface that is depressed or elevated with respect to the main surface;
forwarding the article past a first paint application roller and a second paint application roller;
applying paint via the first paint application roller in a way that a peripheral surface of the first paint application roller is flattened out by the article and reaches a lowermost surface of the main surface and the sub-surface when the article is forwarded past the first paint application roller;
distributing the paint applied by the first paint application roller by the second paint application roller by engaging a peripheral surface of the second paint application roller with the article;
without performing any active curing or drying of the paint applied on the article between the first paint application roller and the second paint application roller.

13. The method according to claim 12, comprising:
applying a pressure of a first magnitude to the article by the first paint application roller; and
applying a pressure of a second magnitude to the article by the second paint application roller;
wherein the pressure applied by the first paint application roller is substantially higher than the pressure applied by the second paint application roller.

14. The method according to claim 12, comprising:
applying a pressure to the article by the first paint application roller in a range of 15-20 g/m².

15. The method according to claim 12, comprising:
applying a pressure to the article by the second paint application roller in a range of 5-10 g/m².

16. The method according to claim 12, comprising:
applying a first layer of paint on the article via the first paint application roller and the second paint application roller;
curing or drying of the first layer of paint applied on the article; and
after the curing or drying, applying a second layer of paint on the article in a similar way as the first layer of paint.

17. The method according to claim 12, comprising:
forwarding the article past the first paint application roller and the second paint application roller with a speed in an interval of 5-50 meter per minute.
